(19) United States
(12) Patent Application Publication
(10) Pub. No.: US 2011/0229249 A1
(43) Pub. Date: Sep. 22, 2011

(54) Penholder

(76) Inventor: Yuan-Ning LEE, Kowloon (HK)

(21) Appl. No.: 12/426,242

(22) Filed: Apr. 18, 2009

(51) Int. Cl. B43K 31/00

(52) U.S. Cl. 401/292

(57) ABSTRACT

A penholder includes primarily an inner sleeve, at least one outer sleeve and a dismountable fixing cap. An outer wall of the inner sleeve is formed with a step at a place close to a bottom end of the inner sleeve. The at least one outer sleeve is sheathed on an outer layer of the inner sleeve, and a bottom end of the outer sleeve is abutted at the step of the inner sleeve. The dismountable fixing cap is provided on a top end of the inner sleeve and forms a limiting function to prevent the outer sleeve from dropping. Therefore, a penholder is provided, wherein by simply replacing the outer sleeve, a pattern, color or even model of the penholder can be changed.

### BACKGROUND OF THE INVENTION

a) Field of the Invention

The present invention relates to a penholder, and more particularly to a penholder which can provide a user to change by oneself a different pattern, color or even model of the penholder.

b) Description of the Prior Art

A pen is one of the most convenient and used most often writing tools in a daily life. Therefore, students, office workers, engineers, business staffs or even ordinary house wives will use the pens frequently. In addition to being equipped with a refill for writing, an ordinary pen should be also provided with a penholder to facilitate holding. Accordingly, there are a lot of pens on the market with various pleasing visual effects by utilizing the model, color and pattern design of the penholder, thereby promoting the market competitiveness.

On the other hand, an ordinary consumer will mostly purchase pens of different writing features and different pen colors to use in different conditions for different requirements of usage. Hence, the market will provide the pens of different functions and pen colors for the consumers to choose, including all kinds of product lines of various refills, such that the consumers can replace the refills by themselves.

However, the pens are primarily featured in appearance by the patterns, colors or even models constituted by the penholders. Thus, some consumers will purchase several pens with a same function and pen color but with different patterns and colors of the penholders, in order to fit with different clothing. Accordingly, not only that cost in purchasing the pens will increase, but also that it will cause a lot of inconvenience in collecting and carrying the pens.

### SUMMARY OF THE INVENTION

Accordingly, the primary object of the present invention is to provide a penholder which can provide a user to change by oneself a different pattern, color or even model of the penholder.

To achieve the aforementioned object, the penholder of the present invention includes primarily an inner sleeve, at least one outer sleeve and a dismountable fixing cap. The inner sleeve is used primarily to emplace a refill, and a step is formed at an outer wall close to a bottom end of the inner sleeve. The at least one outer sleeve is sheathed on an outer layer of the inner sleeve, and a bottom end is abutted at the step of the inner sleeve. The dismountable fixing cap is provided on a top end of the inner sleeve and constitutes a limiting function to the outer sleeve to prevent from dropping.

Accordingly, the entire penholder can utilize the at least one outer sleeve to serve as a main body for modeling and refinishing, allowing the consumer to simply assemble and disassemble the dismountable fixing cap, selectively sheath the outer sleeve of a different model and pattern on the outer layer of the inner sleeve for use, so as to achieve a penholder which provides the user to change by oneself a different pattern, color or even model of the penholder.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of appearance of a first usage state of the present invention.

FIG. 2 shows a schematic view of appearance of a second usage state of the present invention.

FIG. 3 shows an exploded view of structures of the present invention.

FIG. 4 shows a cutaway view of structures of the present invention.

### DETAILED DESCRIPTION OF THE PREFERRED EMBODIMENTS

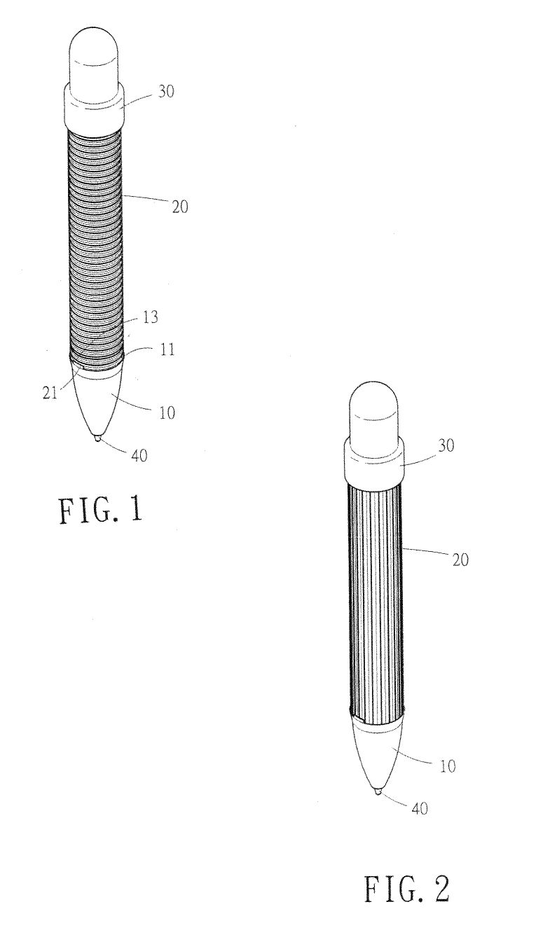

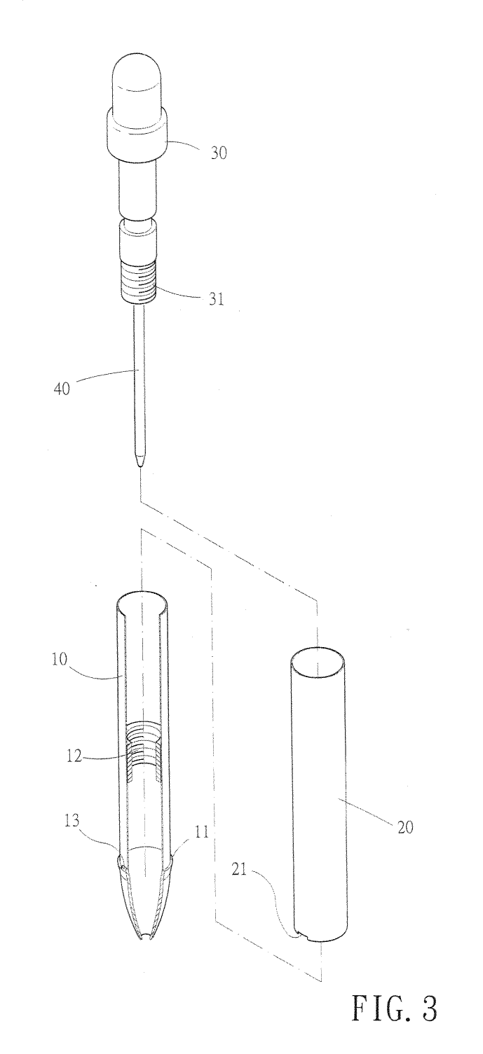

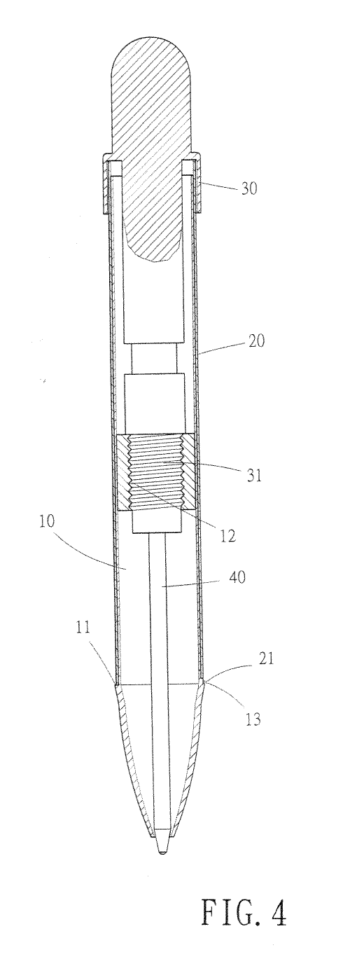

Referring to FIG. 1 and FIG. 2, a penholder of the present invention comprises an inner sleeve 10, at least one outer sleeve 20 and a dismountable fixing cap 30, where by simply replacing the outer sleeve 20, a pattern, color or even model of the penholder can be changed. Referring to FIG. 3 and FIG. 4 at a same time, the inner sleeve 10 is used primarily to emplace a refill 40 and a step 11 is formed at an outer wall, close to a bottom end of the inner sleeve 10. Upon implementing, an inner wall of the inner sleeve 10 is provided with an inner threaded section 12, and the outer wall is provided with at least one protruded member 13.

The at least one outer sleeve 20 is sheathed on an outer layer of the inner sleeve 10, a bottom end of the outer sleeve 20 is abutted at the step 11 of the inner sleeve 10, and the outer sleeve 20 is provided correspondingly with at least one notch 21 into which the protruded member 13 is latched to restrict the outer sleeve 20 to rotate freely.

On the other hand, the dismountable fixing cap 30 is provided on a top end of the inner sleeve 10 and constitutes a limiting function to the outer sleeve 20 to prevent from dropping. Upon implementing, the dismountable fixing cap 30 is provided with an outer threaded section 31 which is extended into the inner sleeve 10, and the outer threaded section 31 is screwed with the inner threaded section 12 of the inner sleeve 10, thereby assembling the dismountable fixing cap 30 with the inner sleeve 10.

Accordingly, the entire penholder of the present invention can utilize the at least one outer sleeve 20 to serve as a main body for modeling and refinishing, and the consumer can easily assemble and disassemble the dismountable fixing cap 30 to choose to sheath the outer sleeve 20 of a different model or pattern on the outer layer of the inner sleeve 10 for use, thereby achieving an effect of easily changing the pattern, color or even model of the penholder.

In particular, upon specifically implementing, the dismountable fixing cap 30 can be inserted with at least one refill 40 in advance, and a pen with the refill 40 will be constituted when the dismountable fixing cap 30 is assembled with the inner sleeve 10.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A penholder comprising an inner sleeve which is used to emplace a refill, with a step being formed at an outer all close to a bottom end of the inner sleeve; at least one outer sleeve, which is sheathed on an outer layer of the inner sleeve and a bottom end of which is abutted at the step of the inner sleeve; and a dismountable fixing cap, which is provided on a top end of the inner sleeve and constitutes a limiting function to prevent the outer sleeve from dropping.

2. The penholder according to claim 1, wherein an inner wall of the inner sleeve is provided with an inner threaded section, the dismountable fixing cap is provided correspondingly with an outer threaded section which is extended into the inner sleeve, and the outer threaded section is screwed with the inner threaded section of the inner sleeve.

3. The penholder according to claim 1, wherein the dismountable fixing cap is inserted with at least one refill in advance.

4. The penholder according to claim 2, wherein the dismountable fixing cap is inserted with at least one refill in advance.

5. The penholder according to claim 1, wherein an outer wall of the inner sleeve is provided with at least one protruded member and the at least one outer sleeve is provided correspondingly with at least one notch into which the protruded member of the inner sleeve is latched.

6. The penholder according to claim 2, wherein an outer wall of the inner sleeve is provided with at least one protruded member and the at least one outer sleeve is provided correspondingly with at least one notch into which the protruded member of the inner sleeve is latched.

7. The penholder according to claim 1, wherein an outer wall of the inner sleeve is provided with at least one protruded member, the at least one outer sleeve is provided correspondingly with at least one notch into which the protruded member of the inner sleeve is latched and the dismountable fixing cap is inserted with at least one refill in advance.

8. The penholder according to claim 2, wherein an outer wall of the inner sleeve is provided with at least one protruded member, the at least one outer sleeve is provided correspondingly with at least one notch into which the protruded member of the inner sleeve is latched and the dismountable fixing cap is inserted with at least one refill in advance.
